(19) United States
(12) Patent Application Publication
(10) Pub. No.: US 2010/0099383 A1
(43) Pub. Date: Apr. 22, 2010

(54) Mobile terminal device

(75) Inventor: Mikimasa Yamagishi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/654,429

(22) Filed: Dec. 18, 2009

Related U.S. Application Data
(63) Continuation of application No. PCT/JP2007/063919, filed on Jul. 12, 2007.

(51) Int. Cl. H04W 12/00

(52) U.S. Cl. 455/411

(57) ABSTRACT

A mobile terminal device includes a communication-setting information storage unit, a validating unit, an emergency-state determining unit, and an emergency notifying unit. The communication-setting information storage unit stores therein communication setting information stored in a removable storage medium. The validating unit validates whether an operator who operates the mobile terminal device is a subscriber. If the validating unit validates that the operator is not the subscriber, the emergency-state determining unit determines that it is an emergency state. If the emergency-state determining unit determines that it is an emergency state, the emergency notifying unit notifies a predetermined emergency contact point of an emergency in accordance with the communication setting information stored in the communication-setting information storage unit.

### CROSS-REFERENCE TO RELATED APPLICATION(S)

This application is a continuation of International Application No. PCT/JP2007/063919, filed on Jul. 12, 2007, the entire contents of which are incorporated herein by reference.

### FIELD

The embodiment discussed herein is directed to a mobile terminal device that, if a predetermined operation is performed, determines that it is an emergency situation and notifies an emergency contact point of current position information and the like.

### BACKGROUND

In the case of the occurrence of theft of a mobile phone or the occurrence of a crime such as a kidnapping of an owner of a mobile phone, a technology for acquiring the current position information from the mobile phone is conventionally used for a criminal investigation.

For example, Japanese Laid-open Patent Publication No. 2006-304175 discloses a technology for notifying an emergency contact point of an emergency situation if the power of a mobile phone is turned off by a third person. Specifically, if the power of the mobile phone is turned off without inputting a password or performing biometric authentication, functions (display function, incoming-tone output function, key operation sounds, and the like), which allows a user to recognize that the mobile phone is in operation, are stopped and a Global Positioning System (GPS) function, a communication function, and the like, which does not allow the user to recognize that the mobile phone is in operation, are activated, whereby the current position information, and the like, of the mobile phone is notified by using the activated functions.

Furthermore, Japanese Laid-open Patent Publication No. 2002-078001 discloses a technology in which a circuit that controls a GPS function and a communication function of a mobile phone and a circuit that controls other functions (display function, Web function, and the like) are separately arranged so that the GPS function and the communication function remain activated even if the power of the mobile phone is turned off, and remote control is performed by a different terminal, whereby the current position information, and the like, of the mobile phone is acquired.

However, the above conventional technology has a problem in that a USIM-card-attached type third-generation mobile phone is not allowed to be used if its USIM card is removed from the mobile phone or replaced with a different USIM card.

Specifically, the above technology is a technology based on the assumption that the mobile phone is in a communication-possible state; however, because communication is not allowed to be performed if the USIM card is removed from the third-generation mobile phone, it is not possible to acquire the current position information, and the like, from the mobile phone.

Furthermore, because the third-generation mobile phone is operated depending on the attached USIM card, if the USIM card is replaced, the telephone number, and the like, are changed, and it is not possible to perform a notification of an emergency situation.

Recently, USIM-card-attached type third-generation mobile phones have been rapidly spreading, and it is generally known that if the USIM card is removed, the mobile phone is not allowed to perform communication. Under such a condition, it is an important issue to find how to achieve a technology that allows the mobile phone to perform a notification of an emergency situation even if the USIM card of the mobile phone is removed or replaced.

### SUMMARY

According to an aspect of an embodiment of the invention, a mobile terminal device includes a removable storage medium that stores therein communication setting information that includes at least an identification number of a subscriber and information for performing communication; a communication-setting information storage unit that stores therein the communication setting information stored in the storage medium; a validating unit that validates whether an operator who operates the mobile terminal device is the subscriber; an emergency-state determining unit that, if the validating unit validates that the operator is not the subscriber, determines that it is an emergency state; and an emergency notifying unit that, if the emergency-state determining unit determines that it is an emergency state, notifies a predetermined emergency contact point of an emergency in accordance with the communication setting information stored in the communication-setting information storage unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an explanatory diagram that illustrates the overview of a mobile phone according to the present embodiment;

FIG. 2 is a functional block diagram that illustrates the configuration of the mobile phone according to the present embodiment;

FIG. 3 is a diagram that illustrates an example of information stored in a USIM card and saved to a communication-setting information table depicted in FIG. 2;

FIG. 4 is a diagram that illustrates an example of a personal information table depicted in FIG. 2;

FIG. 5 is a flowchart to explain the procedure performed upon the operation of turning the power off by the mobile phone depicted in FIG. 2;

FIG. 6 is a flowchart to explain the procedure of the mobile phone if the operation of turning the power on is performed in a state where the USIM card is removed; and

FIG. 7 is a flowchart to explain the procedure of the mobile phone if the operation of turning the power on is performed in a state where the USIM card is attached.

### DESCRIPTION OF EMBODIMENT(S)

Preferred embodiments of the present invention will be explained with reference to accompanying drawings. The present invention is not limited to this embodiment.

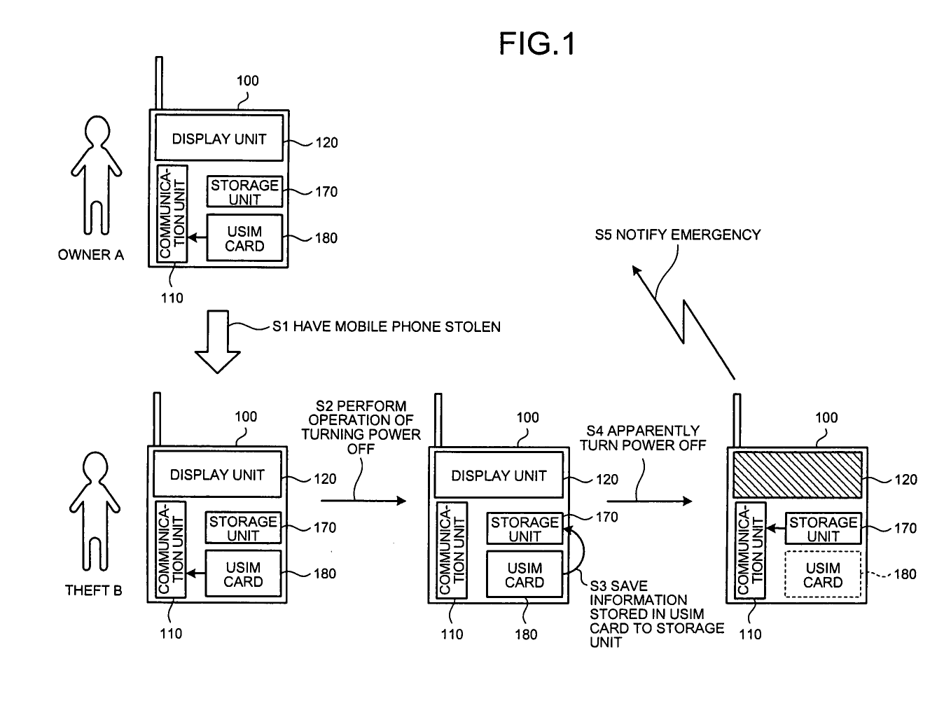

An explanation will be given of the overview of a mobile phone according to the present embodiment. FIG. 1 is an explanatory diagram that explains the overview of the mobile phone according to the present embodiment. As depicted in FIG. 1, a mobile phone 100 is a mobile phone to which a USIM card 180 can be attached. The mobile phone 100 includes a communication unit 110, a display unit 120, and a storage unit 170 and has the USIM card 180 attached thereto.

The communication unit 110 is an operation unit that performs communication control on audio communication and data communication via an undepicted base station. The display unit 120 is a display device formed with a liquid crystal panel or the like. The storage unit 170 is a storage device formed with a nonvolatile memory, such as a flash memory, and stores therein personal identification information for verifying a password, or the like, input to the mobile phone 100, emergency contact point information to which an emergency situation is to be notified, and the like.

The USIM card 180 is an integrated circuit (IC) card that is removable from the mobile phone 100 and stores therein the phone number of the mobile phone 100, information necessary for performing communication, and the like (hereinafter, referred to as “communication setting information”). The communication unit 110 performs communication control on audio communication and data communication on the basis of the communication setting information stored in the USIM card 180.

As depicted in FIG. 1, if the mobile phone 100 is stolen by a thief B (Step S1), it is assumed that the power of the mobile phone 100 is turned off. This is because it is generally known that mobile phones in recent years have a function of automatically performing a notification of an emergency situation. It is also assumed that the USIM card 180 is removed because communication is not allowed to be performed if the USIM card 180 is removed.

Therefore, in the mobile phone 100 according to the present invention, an input of a password is received upon an operation of turning the power off and if the operation of turning the power off is performed without an input of a valid password (Step S2), the communication setting information stored in the USIM card 180 is saved to the storage unit 170 (Step S3). In this manner, the communication unit 110 can perform communication control by using the communication setting information saved to the storage unit 170 even if the USIM card 180 is removed.

Then, the functions that make it recognizable from the outside that the mobile phone 100 is activated are stopped and the functions necessary for an emergency notification remain activated (Step S4). In the example depicted in FIG. 1, the display unit 120 is stopped, and the communication unit 110 and the storage unit 170 remain activated. In the following descriptions, stopping the functions that make it recognizable from the outside that the mobile phone 100 is activated is written as “apparently turning the power off”, and stopping all of the functions of the mobile phone 100 is written as “normally turning the power off”.

Afterward, the mobile phone 100 notifies an emergency contact point of an emergency by using the communication setting information saved to the storage unit 170 (Step S5). The reason why the power is apparently turned off is that it appears as if the mobile phone 100 is correctly terminated and an emergency notification is performed without it being noticed by the thief B.

Thus, in the mobile phone 100 according to the present invention, if the operation of turning the power off is performed by the thief B, the communication setting information stored in the USIM card 180 is saved to the storage unit 170 and the power is apparently turned off, whereby even if the power of the mobile phone 100 is turned off or the USIM card 180 is removed, the communication-possible state can be maintained and the emergency notification can be performed.

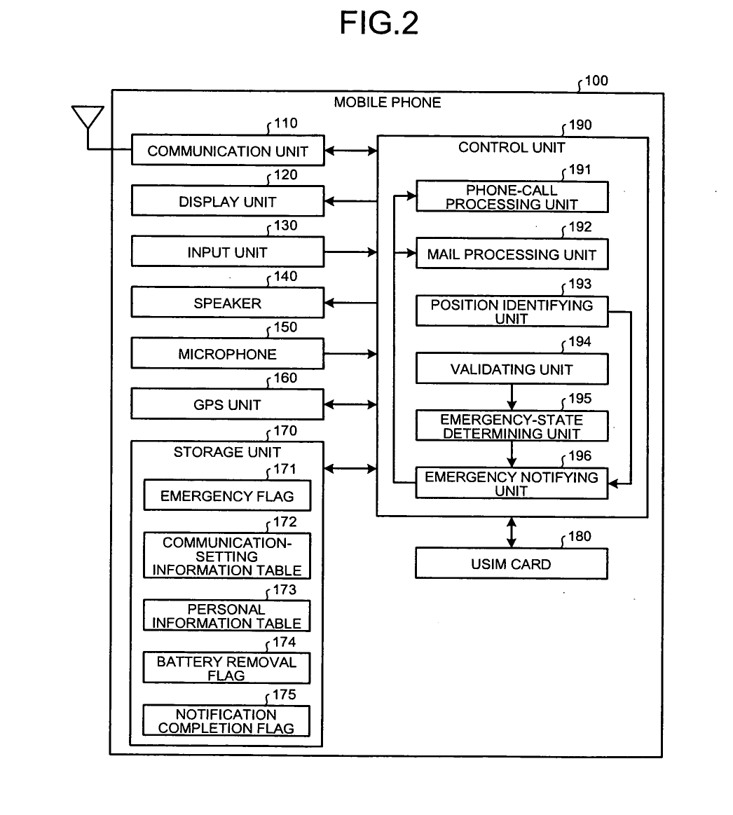

Next, an explanation will be given of the configuration of the mobile phone according to the present embodiment. FIG. 2 is a functional block diagram that illustrates the configuration of the mobile phone according to the present embodiment. As depicted in FIG. 2, the mobile phone 100 includes the communication unit 110, the display unit 120, an input unit 130, a speaker 140, a microphone 150, a GPS unit 160, the storage unit 170, and a control unit 190. The USIM card 180 is attached to the mobile phone 100.

The communication unit 110 is an operation unit that performs communication control on audio communication and data communication via an undepicted base station on the basis of the communication setting information stored in the USIM card 180. The display unit 120 is a display device formed with a liquid crystal panel or the like.

The input unit 130 is an input device formed with a numeric keypad to input numbers, characters, and the like, a power-off key to turn off the mobile phone 100, a power-on key to activate the mobile phone 100, and the like.

The mobile phone 100 receives an input of a password to confirm that, when the operation of turning the power off and the operation of turning the power on are performed, the operation is performed by a valid owner, and the input of the password is performed by using the input unit 130. The input unit 130 outputs the input password to a validating unit 194 that will be described later.

A method of inputting a password upon the operation of turning the power off and the operation of turning the power on will be separately explained. The input of the password upon the operation of turning the power off is performed by using the input unit 130 in a state where the mobile phone 100 is activated. Then, the power-off key of the input unit 130 is pressed to turn off the power of the mobile phone 100 in a state where the input password is displayed on the display unit 120 as upon dialing. That is, a screen for prompting the input of the password is not displayed on the display unit 120. Thus, it is possible to prevent a thief from sensing the need for the input of the password upon the operation of turning the power off.

A method of inputting a password upon the operation of turning the power on is different in the cases where the operation of turning the power on is performed in a state where the power is normally turned off and where the operation of turning the power on is performed in a state where the power is apparently turned off. If the operation of turning the power on is performed in a state where the power is normally turned off, after the power-on key of the input unit 130 is pressed to activate the mobile phone 100, the input of the password is performed on an automatically displayed password entry screen. It is possible to configure it such that after the mobile phone 100 is activated and the initial screen is displayed on the display unit 120, information input within a certain period of time (for example, within 30 seconds) is received as a password, not via the password entry screen. Thus, it is possible to prevent the thief from sensing the need for the input of the password upon the operation of turning the power on.

If the operation of turning the power on is performed in a state where the power is apparently turned off, the input of the password is performed by using the input unit 130 in a state where the power is apparently turned off. Because the display unit 120 is stopped at this time, the password is not displayed on the display unit 120. The power-on key of the input unit 130 is pressed to activate the mobile phone 100. Thus, it is possible to prevent a thief from sensing the need for the input of the password upon the operation of turning the power on. It is possible to configure it such that, after the mobile phone 100 is activated, information input within a certain period of time is received as a password.

If the mobile phone 100 has a fingerprint authentication function, a vein authentication function, or the like, an operation of holding a forefinger, or the like, is performed with the same timing as the input of the password described above, whereby an input of authentication information is received.

The speaker 140 is a device that outputs sounds. For example, the speaker 140 outputs an incoming tone when a phone call is received or a mail is received or outputs the voices of a calling party input from a phone-call processing unit 191 described later.

The microphone 150 is a device that collects ambient sounds and outputs the collected ambient sounds to the phone-call processing unit 191, and, for example, collects the voices of the user during a phone call. The GPS unit 160 is a device that communicates with an undepicted GPS artificial satellite to acquire latitude and longitude information and outputs the acquired latitude and longitude information to a position identifying unit 193 described later.

The storage unit 170 is a storage device formed with a nonvolatile memory, such as a flash memory, and stores therein an emergency flag 171, a communication-setting information table 172, a personal information table 173, a battery removal flag 174, and a notification completion flag 175.

The emergency flag 171 is data that indicates two types of statuses, i.e., a status (hereinafter, referred to as “valid status”) where the power of the mobile phone 100 is turned on with the input of a valid password and a state (hereinafter, referred to as “invalid status”) where the power of the mobile phone 100 is turned on with the input of an invalid password. In the following descriptions, if it is the “valid status”, the emergency flag 171 is set to “0”, and if it is the “invalid status”, the emergency flag 171 is set to “1”.

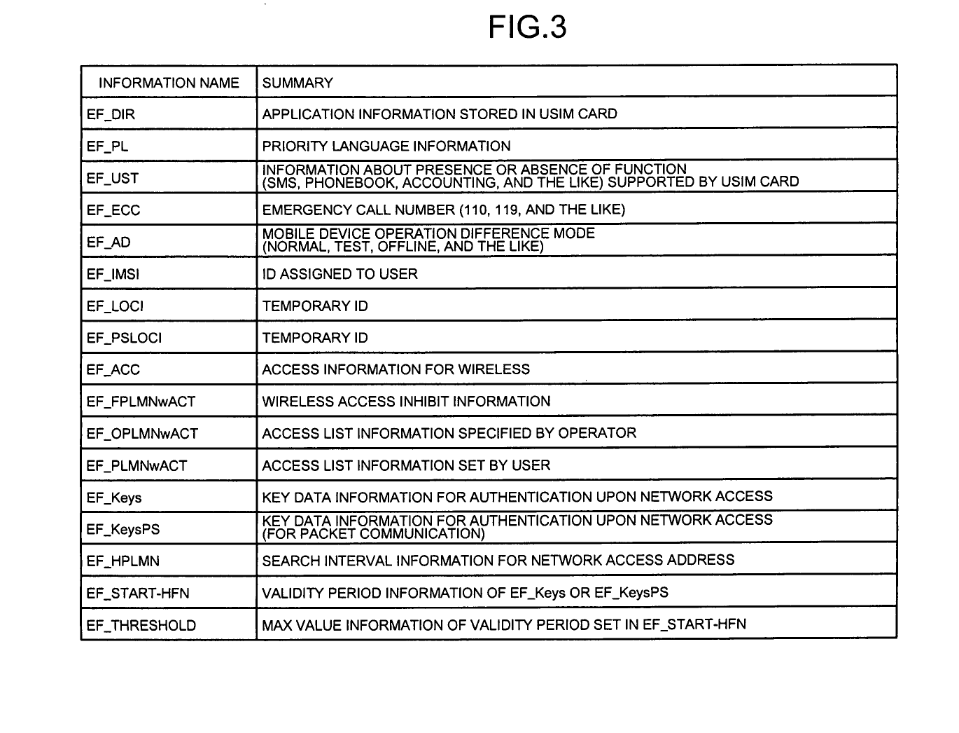

The communication-setting information table 172 is a table to which the communication setting information stored in the USIM card 180 is saved. FIG. 3 is a diagram that illustrates an example of information stored in the USIM card 180 and saved to the communication-setting information table 172 depicted in FIG. 2. The information depicted in FIG. 3 is saved to the communication-setting information table 172 so that the mobile phone 100 can maintain the communication-possible state even if the USIM card 180 is removed from the mobile phone 100.

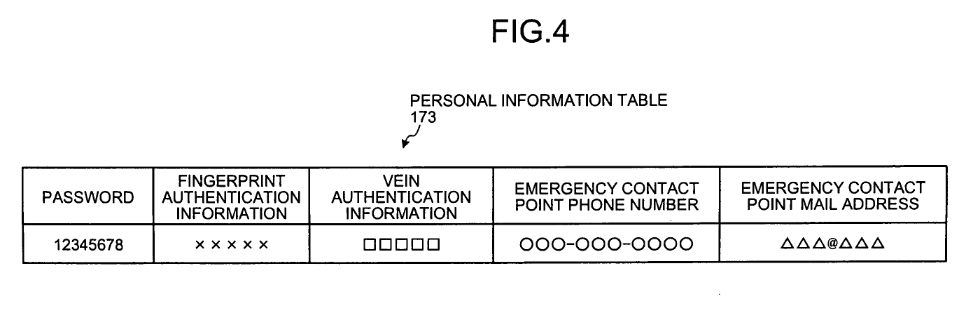

The personal information table 173 is a table that stores therein personal identification information for verifying a password, or the like, input to the mobile phone 100, a contact point to which an emergency is to be notified, and the like. FIG. 4 is a diagram that illustrates an example of the personal information table 173 depicted in FIG. 2. As depicted in FIG. 4, the personal information table 173 stores therein a password, fingerprint authentication information, vein authentication information, an emergency contact point phone number, and an emergency contact point mail address.

Password information composed of alphabetic characters or the like is stored for the password. The fingerprint authentication information is information stored if the mobile phone 100 has a fingerprint authentication function, and feature amount information of a fingerprint of an owner is stored for the fingerprint authentication information. The vein authentication information is information stored if the mobile phone 100 has a vein authentication function, and feature amount information of a vein of an owner is stored for the vein authentication information.

A phone number to which an emergency situation is to be notified is stored for the emergency contact point phone number. A mail address to which an emergency situation is to be notified is stored for the emergency contact point mail address. The emergency contact point phone number and the emergency contact point mail address are, for example, a contact point of a family, an address of a specific server, a contact point of the police, or the like.

The battery removal flag 174 is data that indicates whether a battery pack is removed in a state where the mobile phone 100 is activated. In the following descriptions, if the power-off key is pressed to turn the power off, the battery removal flag 174 is set to “0”, and in the other cases (if the battery pack is removed in a state where the mobile phone 100 is activated or the like), the battery removal flag 174 is set to “1”. The timing with which the status of the battery removal flag 174 is updated will be described in detail later.

The notification completion flag 175 is data that indicates whether an emergency notification has been performed by an emergency notifying unit 196 described later. The notification completion flag 175 is used when an emergency-state determining unit 195 described later displays an emergency notification result, for example, “an emergency situation was notified to ###@### at # hours # minutes on # day # month” on the display unit 120. In the following descriptions, if the emergency notification has not been performed, the notification completion flag 175 is set to “0”, and if the emergency notification has been performed, the notification completion flag 175 is set to

The USIM card 180 is an IC card that can be removed from the mobile phone 100 and stores therein the communication setting information. Although the communication unit 110 performs communication control on audio communication and data communication on the basis of the communication setting information stored in the USIM card 180 as described above, the communication unit 110 performs communication control on the basis of the communication setting information stored in the communication-setting information table 172 when performing an emergency notification.

The control unit 190 is a control unit that controls the entire mobile phone 100 and, for example, performs phone-call control when calling to a different phone, e-mail control to transmit and receive an e-mail, Web control to view Web pages via the Internet, and the like.

The control unit 190 includes the phone-call processing unit 191, a mail processing unit 192, the position identifying unit 193, the validating unit 194, the emergency-state determining unit 195, and the emergency notifying unit 196. The phone-call processing unit 191 is a processing unit that performs a phone-call connection process, such as call connection, via a base station and a telephone switching network. The mail processing unit 192 is a processing unit that performs various types of processes relating to e-mails, such as a creation process, a transmitting process, a receiving process, a display process, and the like of e-mails.

The position identifying unit 193 identifies the current position of the mobile phone 100 by using area information about a base station within a communication area and the latitude and longitude information received from the GPS unit 160 and outputs the identified current position information to the emergency notifying unit 196.

The validating unit 194 is an operation unit that validates whether the password input via the input unit 130 matches the password stored in the personal information table 173 and outputs, to the emergency-state determining unit 195, a validation result of “valid” if they match or “invalid” if they do not match or the password is not input.

If the mobile phone 100 has a fingerprint authentication function or a vein authentication function, for example, the validating unit 194 acquires feature amount information of a fingerprint or vein when the operation of holding a forefinger, or the like, over an undepicted hold unit is performed and determines whether the acquired feature amount information matches the fingerprint authentication information or the vein authentication information stored in the personal information table 173.

The emergency-state determining unit 195 is an operation unit that determines whether it is an emergency state when the operation of turning off the power of the mobile phone 100 or the operation of turning on the power of the mobile phone 100 is performed and, if it is determined that it is an emergency state, instructs the emergency notifying unit 196 to perform an emergency notification. It is determined whether it is an emergency state in accordance with the validation result received from the validating unit 194, the value of the emergency flag 171, and the value of the battery removal flag 174. The process performed by the emergency-state determining unit 195 upon the operation of turning the power off and the operation of turning the power on will be explained below separately.

First, an explanation will be given of the process performed by the emergency-state determining unit 195 upon the operation of turning the power off. Upon the operation of turning the power off, even if the emergency flag 171 and the battery removal flag 174 has any value, if the validation result upon the operation of turning the power off, which has been received from the validating unit 194, is “invalid” (that is, if the operation of turning the power off is performed by a person other than the owner of the mobile phone 100), the emergency-state determining unit 195 determines that it is an emergency state and instructs the emergency notifying unit 196 to perform an emergency notification.

In such a case, the emergency-state determining unit 195 updates the emergency flag 171 to “1 (invalid status)” and saves the communication setting information stored in the USIM card 180 to the communication-setting information table 172. Afterward, the power of the mobile phone 100 is apparently turned off. For example, the display unit 120, the speaker 140, and the microphone 150 are stopped and other units such as the communication unit 110 remain activated.

The reason why the emergency flag 171 is updated to “1 (invalid status)” is that the state where the power is turned off with the input of the invalid password is maintained, whereby the emergency can be notified upon the operation of turning the power on. An emergency notifying process upon the operation of turning the power on will be described later.

If the validation result received from the validating unit 194 is “valid” (that is, the operation of turning the power off is performed by the owner of the mobile phone 100), the emergency-state determining unit 195 determines that it is not an emergency state and does not give an instruction to the emergency-state determining unit 195.

In such a case, the emergency-state determining unit 195 updates the battery removal flag 174 to “0 (absence of battery removal)”, deletes the communication setting information stored in the communication-setting information table 172, and then turns off the power of the mobile phone 100. It is possible to configure it such that information stored in the communication-setting information table 172 is not deleted.

Next, an explanation will be given of the process performed by the emergency-state determining unit 195 upon the operation of turning the power on. The process performed by the emergency-state determining unit 195 upon the operation of turning the power on can be divided into three cases, i.e., (1) if the emergency flag 171 is “1 (invalid status)”, (2) if the emergency flag 171 is “0 (valid status)” and the battery removal flag 174 is “1 (presence of battery removal)”, and (3) if the emergency flag 171 is “0 (valid status)” and the battery removal flag 174 is “0 (absence of battery removal)”. The process performed by the emergency-state determining unit 195 will be explained below for the divided cases (1) to (3).

First, an explanation will be given of the case (1) where the emergency flag 171 is “1 (invalid status)”. Even if the battery removal flag 174 has any value, if the emergency flag 171 is “1 (invalid status)” (that is, if the operation of turning the power on is performed after the operation of turning the power off is performed by a person other than the owner of the mobile phone 100), the emergency-state determining unit 195 determines whether the USIM card 180 is attached to the mobile phone 100.

If the USIM card 180 is not attached to the mobile phone 100 and if the validation result upon the operation of turning the power on, which has been received from the validating unit 194, is “invalid”, the emergency-state determining unit 195 determines that it is an emergency state and instructs the emergency notifying unit 196 to perform an emergency notification. In such a case, the emergency-state determining unit 195 apparently turns off the power of the mobile phone 100.

If the validation result is “valid”, the emergency-state determining unit 195 inquires of the user as to whether the user is to urgently use the mobile phone 100 in a state where the USIM card 180 is removed. The reason why the inquiry is made is that, if only the USIM card 180 is stolen, the owner sometimes desires to use the mobile phone 100.

If the user desires to urgently use the mobile phone 100, the emergency-state determining unit 195 puts the mobile phone 100 in a communication-possible state by using the communication setting information stored in the communication-setting information table 172. Thus, the user can use the mobile phone 100 even in a state where the USIM card 180 is removed. In this case, the emergency-state determining unit 195 also determines that it is an emergency state and instructs the emergency notifying unit 196 to perform an emergency notification.

If the user does not desire to urgently use the mobile phone 100, the emergency-state determining unit 195 updates the battery removal flag 174 to “1 (presence of battery removal)” and activates the mobile phone 100. Afterward, if the notification completion flag 175 is “1 (presence of notification)”, the emergency-state determining unit 195 displays an emergency notification result, for example, “an emergency situation was notified to ###@### at # hours # minutes on # day # month” on the display unit 120 and updates the notification completion flag 175 to “0 (absence of notification)”. Thus, the user can confirm that the emergency notification has been performed as needed.

An explanation will be given of the reason why the battery removal flag 174 is updated to “1 (presence of battery removal)”. Normally, if the battery pack is removed in a state where the mobile phone 100 is activated, the battery removal flag 174 needs to be updated to “1 (presence of battery removal)”; however, because the power is instantaneously turned off, such a process is not allowed to be performed. Therefore, the battery removal flag 174 is always set to “1 (presence of battery removal)” while the mobile phone 100 is activated, and the battery removal flag 174 is updated to “0 (absence of battery removal)” only if the operation of turning the power off is performed with the input of a valid password.

If the USIM card 180 is attached to the mobile phone 100, the emergency-state determining unit 195 compares the communication setting information stored in the USIM card 180 with the communication setting information stored in the communication-setting information table 172.

If the pieces of the communication setting information are different from each other as a result of the comparison, the emergency-state determining unit 195 determines that it is an emergency state and instructs the emergency notifying unit 196 to perform an emergency notification. In such a case, the emergency-state determining unit 195 apparently turns off the power of the mobile phone 100.

It is possible that the power is not apparently turned off and all of operation units of the mobile phone 100 are activated so that the mobile phone 100 can be used in a state where the USIM card 180 is replaced. In this manner, it is possible to perform an emergency notification while the thief feels safe to use the mobile phone 100.

If the pieces of the communication setting information are identical to each other and if the validation result upon the operation of turning the power on, which has been received from the validating unit 194, is “invalid”, the emergency-state determining unit 195 determines that it is an emergency state and instructs the emergency notifying unit 196 to perform an emergency notification. In such a case, the emergency-state determining unit 195 apparently turns off the power of the mobile phone 100.

If the validation result is “valid”, the emergency-state determining unit 195 saves the communication setting information stored in the USIM card 180 to the communication-setting information table 172. The emergency-state determining unit 195 then updates the emergency flag 171 to “0 (valid status)”, updates the battery removal flag 174 to “1 (presence of battery removal)”, and then activates the mobile phone 100. Afterward, if the notification completion flag 175 is “1 (presence of notification)”, the emergency-state determining unit 195 displays the emergency notification result on the display unit 120 and updates the notification completion flag 175 to “0 (absence of notification)”.

Next, an explanation will be given of the case (2) where the emergency flag 171 is “0 (valid status)” and the battery removal flag 174 is “1 (presence of battery removal)”. In such a case, the process performed by the emergency-state determining unit 195 is the same as that performed in the case (1) where the emergency flag 171 is “1 (invalid status)”.

Next, an explanation will be given of the case (3) where the emergency flag 171 is “0 (valid status)” and the battery removal flag 174 is “0 (absence of battery removal)”. In such a case, the emergency-state determining unit 195 determines whether the USIM card 180 is attached to the mobile phone 100.

If the USIM card 180 is not attached to the mobile phone 100, the emergency-state determining unit 195 updates the battery removal flag 174 to “1 (presence of battery removal)” and activates the mobile phone 100. Afterward, if the notification completion flag 175 is “1 (presence of notification)”, the emergency-state determining unit 195 displays the emergency notification result on the display unit 120 and updates the notification completion flag 175 to “0 (absence of notification)”.

If the USIM card 180 is attached to the mobile phone 100, the emergency-state determining unit 195 saves the communication setting information stored in the USIM card 180 to the communication-setting information table 172. The emergency-state determining unit 195 updates the emergency flag 171 to “0 (valid status)”, updates the battery removal flag 174 to “1 (presence of battery removal)”, and then activates the mobile phone 100. Afterward, if the notification completion flag 175 is “1 (presence of notification)”, the emergency-state determining unit 195 displays the emergency notification result on the display unit 120 and updates the notification completion flag 175 to “0 (absence of notification)”.

Although the case has been explained where, if the emergency flag 171 is “0 (valid status)” and the battery removal flag 174 is “0 (absence of battery removal)”, the emergency notification is not performed regardless of the validation result upon the operation of turning the power on, which is received from the validating unit 194, it is possible to configure it such that the emergency notification is always performed if the validation result is “invalid”.

Referring back to FIG. 2, the emergency notifying unit 196 is an operation unit that notifies an emergency contact point of an emergency situation. Specifically, the emergency notifying unit 196 notifies an emergency contact point phone number or an emergency contact point mail address stored in the personal information table 173 of the current position information received from the position identifying unit 193, information stored in the communication-setting information table 172, information stored in the USIM card 180, a fixed emergency message, or the like.

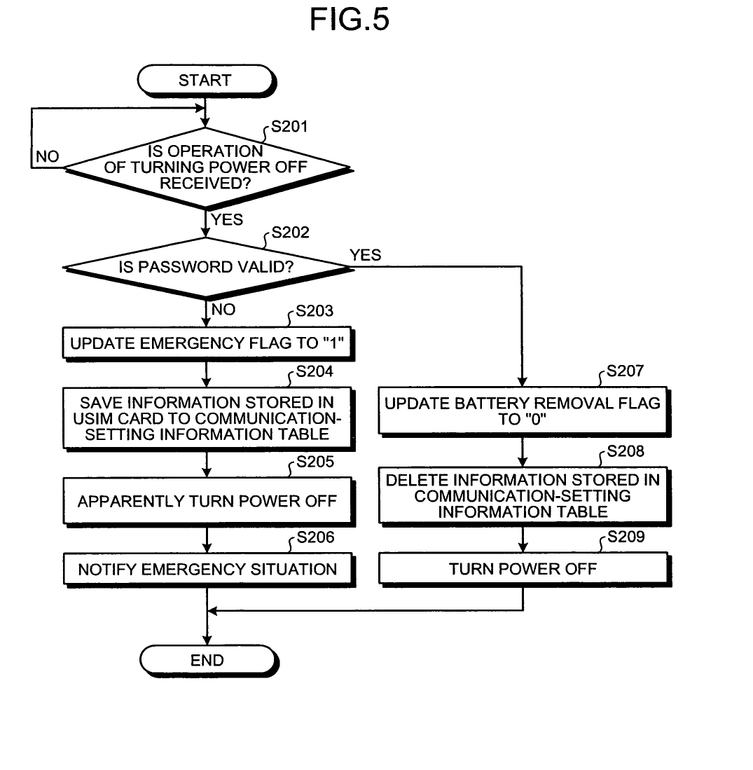

Next, an explanation will be given of a procedure performed upon the operation of turning the power off by the mobile phone 100 depicted in FIG. 2. FIG. 5 is a flowchart to explain the procedure performed upon the operation of turning the power off by the mobile phone 100 depicted in FIG. 2.

Upon receiving the operation of turning the power off via the input unit 130 (Yes at Step S201), the validating unit 194 validates whether the password input upon the operation of turning the power off matches the password stored in the personal information table 173 and outputs the validation result to the emergency-state determining unit 195.

If the validation result is “invalid” (No at Step S202), the emergency-state determining unit 195, which has received the validation result from the validating unit 194, determines that it is an emergency state, instructs the emergency notifying unit 196 to perform an emergency notification, updates the emergency flag 171 to “1 (invalid status)” (Step S203), saves the communication setting information stored in the USIM card 180 to the communication-setting information table 172 (Step S204), and then apparently turns off the power of the mobile phone 100 (Step S205).

The emergency notifying unit 196, which has received the instruction from the emergency-state determining unit 195, notifies the emergency contact point phone number or the emergency contact point mail address stored in the personal information table 173 of an emergency situation that includes the current position information received from the position identifying unit 193 on the basis of the communication setting information stored in the communication-setting information table 172 (Step S206).

Even if the USIM card 180 is attached to the mobile phone 100, the emergency notification is performed on the basis of the communication setting information saved to the communication-setting information table 172. Thus, the power of a USIM card access unit can be turned off and the battery consumption of the mobile phone 100 in an emergency state can be reduced.

If the validation result is “valid” (Yes at Step S202), the emergency-state determining unit 195 updates the battery removal flag 174 to “0 (absence of battery removal)” (Step S207), deletes the communication setting information stored in the communication-setting information table 172 (Step S208), and then turns off the power of the mobile phone 100 (Step S209).

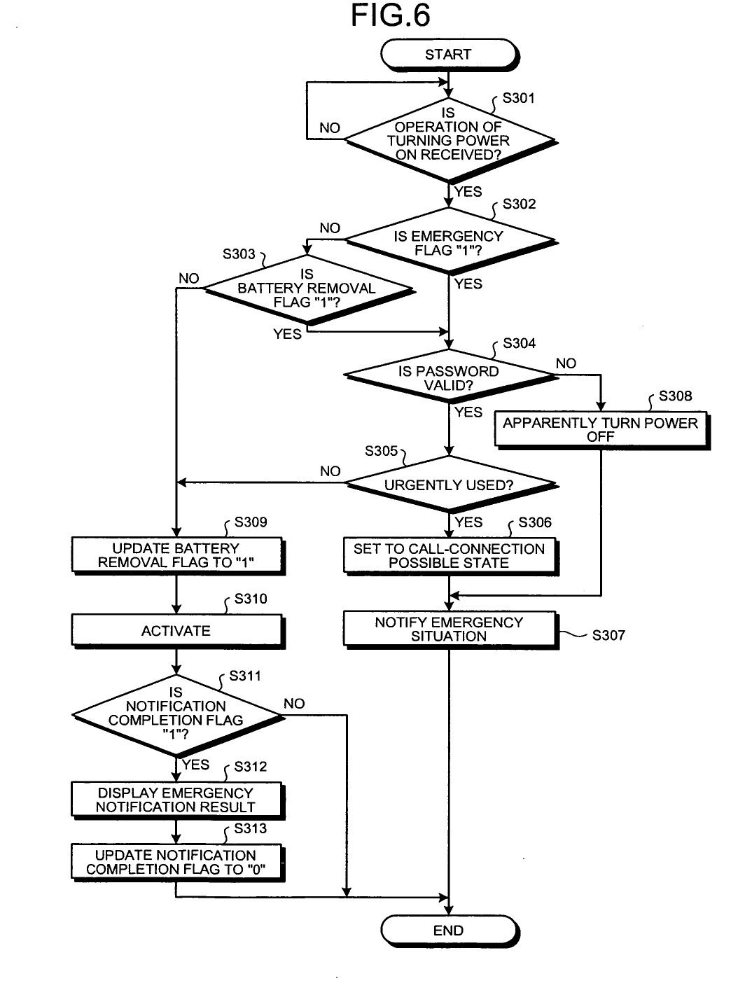

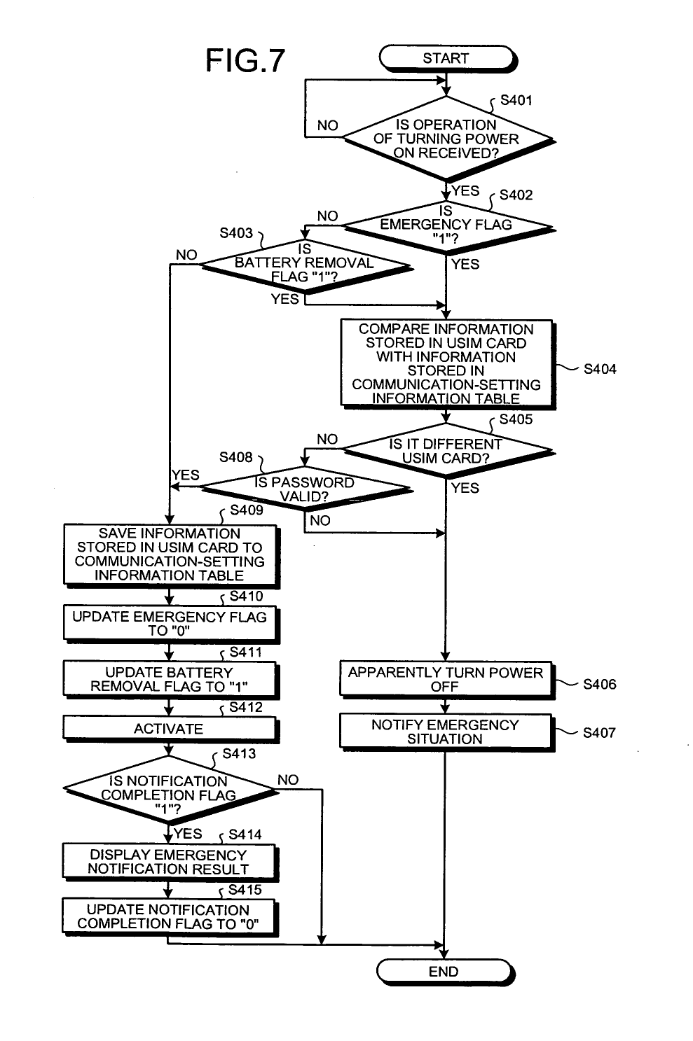

Next, an explanation will be give of a procedure performed upon the operation of turning the power on by the mobile phone 100 depicted in FIG. 2. For ease of explanations, an explanation will be separately given of the case where the operation of turning the power on is performed in a state where the USIM card 180 is removed (FIG. 6) and the case where the operation of turning the power on is performed in a state where the USIM card 180 is attached (FIG. 7). The procedure performed in the case where the operation of turning the power on is performed in a state where the power is normally turned off is the same as that performed in the case where the operation of turning the power on is performed in a state where the power is apparently turned off.

First, an explanation will be given of a procedure of the mobile phone 100 if the operation of turning the power on is performed in a state where the USIM card 180 is removed. FIG. 6 is a flowchart to explain the procedure of the mobile phone 100 if the operation of turning the power on is performed in a state where the USIM card 180 is removed.

Upon receiving the operation of turning the power on via the input unit 130 (Yes at Step S301), the validating unit 194 validates whether the password input upon the operation of turning the power on matches the password stored in the personal information table 173 and outputs the validation result to the emergency-state determining unit 195.

The emergency-state determining unit 195, which has received the validation result from the validating unit 194, acquires the emergency flag 171 and the battery removal flag 174 and, if the acquired emergency flag 171 is “1 (invalid status)” (Yes at Step S302) or if the emergency flag 171 is “0 (valid status)” (No at Step S302) and the battery removal flag 174 is “1 (presence of battery removal)” (Yes at Step S303), and if the validation result is “invalid” (No at Step S304), the emergency-state determining unit 195 determines that it is an emergency state, instructs the emergency notifying unit 196 to perform an emergency notification, and then apparently turns off the power of the mobile phone 100 (Step S308).

The emergency notifying unit 196, which has received an instruction from the emergency-state determining unit 195, notifies the emergency contact point phone number or the emergency contact point mail address stored in the personal information table 173 of an emergency situation that includes the current position information received from the position identifying unit 193 on the basis of the communication setting information stored in the communication-setting information table 172 (Step S307).

If the validation result is “valid” (Yes at Step S304), the emergency-state determining unit 195 inquires of the user as to whether the user is to urgently use the mobile phone 100 in a state where the USIM card 180 is removed (Step S305).

If the user desires to urgently use the mobile phone 100, the emergency-state determining unit 195 puts the mobile phone 100 in a communication-possible state by using the communication setting information stored in the communication-setting information table 172 (Step S306). The emergency-state determining unit 195 then determines that it is an emergency state and instructs the emergency notifying unit 196 to perform an emergency notification.

The emergency notifying unit 196, which has received the instruction, notifies the emergency contact point phone number or the emergency contact point mail address stored in the personal information table 173 of an emergency situation that includes the current position information received from the position identifying unit 193 on the basis of the communication setting information stored in the communication-setting information table 172 (Step S307).

If the user does not desire to urgently use the mobile phone 100 (No at Step S305), the emergency-state determining unit 195 updates the battery removal flag 174 to “1 (presence of battery removal)” (Step S309) and activates the mobile phone 100 (Step S310).

Afterward, if the notification completion flag 175 is “1 (presence of notification)” (Yes at Step S311), the emergency-state determining unit 195 displays an emergency notification result on the display unit 120 (Step S312) and updates the notification completion flag 175 to “0 (absence of notification)” (Step S313).

If the emergency flag 171 is “0 (valid status)” (No at Step S302) and the battery removal flag 174 is “0 (absence of battery removal)” (No at Step S303), the emergency-state determining unit 195 updates the battery removal flag 174 to “1 (presence of battery removal)” (Step S309) and activates the mobile phone 100 (Step S310).

Afterward, if the notification completion flag 175 is “1 (presence of notification)” (Yes at Step S311), the emergency-state determining unit 195 displays an emergency notification result on the display unit 120 (Step S312) and updates the notification completion flag 175 to “0 (absence of notification)” (Step S313).

Next, an explanation will be given of a procedure of the mobile phone 100 if the operation of turning the power on is performed in a state where the USIM card 180 is attached to the mobile phone 100. FIG. 7 is a flowchart to explain the procedure of the mobile phone 100 if the operation of turning the power on is performed in a state where the USIM card 180 is attached to the mobile phone 100.

Upon receiving the operation of turning the power on via the input unit 130 (Yes at Step S401), the validating unit 194 validates whether the password input upon the operation of turning the power on matches the password stored in the personal information table 173 and outputs the validation result to the emergency-state determining unit 195.

The emergency-state determining unit 195, which has received the validation result from the validating unit 194, acquires the emergency flag 171 and the battery removal flag 174 and, if the acquired emergency flag 171 is “1 (invalid status)” (Yes at Step S402) or if the emergency flag 171 is “0 (valid status)” (No at Step S402) and the battery removal flag 174 is “1 (presence of battery removal)” (Yes at Step S403), the emergency-state determining unit 195 compares the communication setting information stored in the USIM card 180 with the communication setting information stored in the communication-setting information table 172 (Step S404).

If the pieces of the communication setting information are different from each other (Yes at Step S405), the emergency-state determining unit 195 determines that it is an emergency state, instructs the emergency notifying unit 196 to notify an emergency, and apparently turns off the power of the mobile phone 100 (Step S406).

The emergency notifying unit 196, which has received the instruction, notifies the emergency contact point phone number or the emergency contact point mail address stored in the personal information table 173 of an emergency situation that includes the current position information received from the position identifying unit 193 and the information stored in the attached USIM card 180 on the basis of the communication setting information stored in the communication-setting information table 172 (Step S407).

If the pieces of the communication setting information are identical to each other (No at Step S405), and if the validation result upon the operation of turning the power on, which has been received from the validating unit 194, is “invalid” (No at Step S408), the emergency-state determining unit 195 determines that it is an emergency state, instructs the emergency notifying unit 196 to perform an emergency notification, and apparently turns off the power of the mobile phone 100 (Step S406).

The emergency notifying unit 196, which has received the instruction, notifies the emergency contact point phone number or the emergency contact point mail address stored in the personal information table 173 of an emergency situation that includes the current position information received from the position identifying unit 193 on the basis of the communication setting information stored in the communication-setting information table 172 (Step S407).

If the validation result is “valid” (Yes at Step S408), the emergency-state determining unit 195 saves the communication setting information stored in the USIM card 180 to the communication-setting information table 172 (Step S409).

The emergency-state determining unit 195 then updates the emergency flag 171 to “0 (valid status)” (Step S410), updates the battery removal flag 174 to “1 (presence of battery removal)” (Step S411), and then activates the mobile phone 100 (Step S412).

Afterward, if the notification completion flag 175 is “1 (presence of notification)” (Yes at Step S413), the emergency-state determining unit 195 displays the emergency notification result on the display unit 120 (Step S414) and updates the notification completion flag 175 to “0 (absence of notification)” (Step S415).

If the emergency flag 171 is “0 (valid status)” (No at Step S402) and the battery removal flag 174 is “0 (absence of battery removal)” (No at Step S403), the emergency-state determining unit 195 saves the communication setting information stored in the USIM card 180 to the communication-setting information table 172 (Step S409).

The emergency-state determining unit 195 then updates the emergency flag 171 to “0 (valid status)” (Step S410), updates the battery removal flag 174 to “1 (presence of battery removal)” (Step S411), and then activates the mobile phone 100 (Step S412).

Afterward, if the notification completion flag 175 is “1 (presence of notification)” (Yes at Step S413), the emergency-state determining unit 195 displays the emergency notification result on the display unit 120 (Step S414) and updates the notification completion flag 175 to “0 (absence of notification)” (Step S415).

As described above, the above embodiment has the configuration such that, an input of authentication information is received upon the operation of turning the power off or the operation of turning the power on, and, if it is determined that the authentication information received by the validating unit 194 does not match the personal identification information stored in the personal information table 173, the emergency-state determining unit 195 determines that it is an emergency state and instructs the emergency notifying unit 196 to perform an emergency notification and the emergency notifying unit 196, which has received the instruction, notifies the emergency contact point phone number, or the like, stored in the personal information table 173 of the emergency on the basis of the communication setting information stored in the communication-setting information table 172, whereby it is possible to definitely notify the emergency situation even if the USIM card 180 is removed or replaced.

Although an explanation is given in the above embodiment of the case where personal authentication is performed and an emergency notification is performed if it is determined that the operator who is operating the mobile phone 100 is not the valid owner of the mobile phone 100, the present invention is not limited to this. It is possible to configure it such that the emergency notification is performed without performing personal authentication. Specifically, a phone number stored in the USIM card 180 is stored in the storage unit 170 and, if a USIM card in which a phone number other than the phone number stored in the storage unit 170 is stored is attached or a USIM card is not attached, it is determined that it is an emergency state and the emergency notification is performed. Information to be stored in the storage unit 170 is not limited to a phone number, and an identification number (manufacturing number or the like) of the USIM card 180 can be stored.

Furthermore, although it is explained in the above embodiment that an IC card attached to the mobile phone 100 is the USIM card 180, the present invention is not limited to this. It can be any IC card in which a unique ID number for identifying an identification number of a subscriber is stored.

Moreover, although an explanation is given of the case where, if it is determined that it is an emergency state, the emergency notification is always performed, the present invention is not limited to this. It is possible to configure it such that modes, i.e., “normal mode” or “emergency mode”, are provided and, only if the “emergency mode” is selected by a user, functions as described above, i.e., the function of saving the information stored in the USIM card 180 to the communication-setting information table 172, the function of inputting the authentication information upon the operation of turning the power on/off, the function of performing the emergency notification, and the like, are executed. Thus, it is not necessary to input a password every time the operation of turning the power on/off is performed.

According to an embodiment, there is an advantage that, if a mobile terminal device is operated by a third person, a notification of an emergency situation can be automatically performed.

Furthermore, according to an embodiment, there is an advantage that, if the operation of turning off the power of the mobile terminal device is performed by a third person, a notification of an emergency situation can be automatically performed.

Moreover, according to an embodiment, there is an advantage that, even if the mobile terminal device is removed from a storage medium or replaced, a notification of an emergency situation can be definitely performed by using communication setting information saved to a predetermined storage unit.

Furthermore, according to an embodiment, there is an advantage that, if the operation of turning off the power of the mobile terminal device is performed by an owner, personal information saved to the predetermined storage unit can be deleted. For example, if a subscriber replaces or discards the mobile terminal device, it is not necessary to delete the communication setting information that includes the personal information from the mobile terminal device.

Moreover, according to an embodiment, there is an advantage that it appears as if the mobile terminal device is correctly terminated and a notification of an emergency situation can be performed without it being noticed by a third person.

Further, according to an embodiment, there is an advantage that, if the operation of turning on the power of the mobile terminal device is performed by a third person, a notification of an emergency situation can be automatically performed.

Moreover, according to an embodiment, there is an advantage that, if the power of the mobile terminal device is turned on after the power of the mobile terminal device is turned off by a third person, a notification of an emergency situation can be automatically performed.

Furthermore, according to an embodiment, there is an advantage that, if the power of the mobile terminal device is turned on after the battery is removed without performing the operation of turning off the power of the mobile terminal device, a notification of an emergency situation can be automatically performed.

Moreover, according to an embodiment, if the storage medium is removed from the mobile terminal device or replaced, a notification of an emergency situation can be automatically performed.

Furthermore, according to an embodiment, even if the storage medium is removed from the mobile terminal device or replaced, a notification of an emergency situation can be definitely performed by using the communication setting information saved to the predetermined storage unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A mobile terminal device comprising:
a removable storage medium that stores therein communication setting information that includes at least an identification number of a subscriber and information for performing communication;
a communication-setting information storage unit that stores therein the communication setting information stored in the storage medium;
a validating unit that validates whether an operator who operates the mobile terminal device is the subscriber;
an emergency-state determining unit that, if the validating unit validates that the operator is not the subscriber, determines that it is an emergency state; and
an emergency notifying unit that, if the emergency-state determining unit determines that it is an emergency state, notifies a predetermined emergency contact point of an emergency in accordance with the communication setting information stored in the communication-setting information storage unit.

2. The mobile terminal device according to claim 1, wherein the validating unit performs validation if an operation of turning power off is performed.

3. The mobile terminal device according to claim 1, wherein
the validating unit performs validation if an operation of turning power off is performed, and
if the validating unit validates that the operator is not the subscriber, the emergency-state determining unit saves the communication setting information stored in the storage medium to the communication-setting information storage unit.

4. The mobile terminal device according to claim 3, wherein if the validating unit validates that the operator is the subscriber, the emergency-state determining unit deletes information stored in the communication-setting information storage unit.

5. The mobile terminal device according to claim 1, wherein
if the validating unit validates that the operator is not the subscriber, the emergency-state determining unit stops a function that makes it recognizable from outside that the mobile terminal device is in operation, and
the emergency notifying unit performs a notification of an emergency by using a function that is not stopped by the emergency-state determining unit.

6. The mobile terminal device according to claim 1, wherein the validating unit performs validation if an operation of turning power on is performed.

7. The mobile terminal device according to claim 2, further comprising an emergency-flag storage unit that stores therein an emergency flag that indicates a difference between a valid status that indicates that the validating unit has validated the operator is the subscriber and an invalid status that indicates that the validating unit has validated the operator is not the subscriber, wherein
if the validating unit validates that the operator is not the subscriber, the emergency-state determining unit updates the emergency flag to the invalid status and, if the emergency flag indicates the invalid status when the operation of turning the power on is performed, determines that it is an emergency state.

8. The mobile terminal device according to claim 1, further comprising a battery-removal flag storage unit that stores therein a battery removal flag that indicates presence or absence of battery removal as to whether a battery has been removed during power up of the mobile terminal device, wherein
the emergency-state determining unit determines that it is an emergency state if the battery removal flag indicates the presence of the battery removal.

9. The mobile terminal device according to claim 1, wherein the emergency-state determining unit compares communication setting information stored in the storage medium with communication setting information stored in the communication-setting information storage unit and, if the communication setting information stored in the storage medium is different from the communication setting information stored in the communication-setting information storage unit, determines that it is an emergency state.

10. The mobile terminal device according to claim 1, wherein
the validating unit performs validation if an operation of turning power on is performed, and if the validating unit validates that the operator is the subscriber, the emergency-state determining unit saves the communication setting information stored in the storage medium to the communication-setting information storage unit.
